(19) United States
(12) Patent Application Publication
(10) Pub. No.: US 2017/0164369 A1
(43) Pub. Date: Jun. 8, 2017

(54) MULTIPLE ACCESS SYSTEM FOR MULTIPLE USERS TO USE THE SAME SIGNATURE

(71) Applicants: National Taiwan University, Taipei City (TW); MEDIATEK INC., Hsin-Chu (TW)

(72) Inventors: Mao-Chao Lin, Taipei City (TW); Chia-Fu Chang, Yunlin County (TW); Yen-Ching Liu, Keelung City (TW); Kai-Chun Cheng, Taipei City (TW)

(21) Appl. No.: 15/365,949

(22) Filed: Dec. 1, 2016

Related U.S. Application Data
(60) Provisional application No. 62/261,892, filed on Dec. 2, 2015.
(60) Provisional application No. 62/355,320, filed on Jun. 27, 2016.

(51) Int. Cl. H04W 72/04; H04W 48/16; H04W 72/08

(52) U.S. Cl. CPC H04W 72/0466; H04W 72/082; H04W 48/16

(57) ABSTRACT

A multiple access communication system in which receiving devices equipped with a method of differentiating signals from multiple users assigned with the same signature, the method comprising steps of determining a plurality of hypothetical signal levels according to a plurality of channel information; obtaining a pre-processed signal according to a received signal received by the receiving device, wherein the pre-processed signal comprises a mixture of a plurality of transmitted signals, and the transmitted signals are generated according to a plurality of signatures and encoded according to a plurality of data signals; calculating a plurality of symbol-level probabilities according to the pre-processed signal and the hypothetical signal levels, wherein the number of signatures may be less than the number of users; obtaining a plurality of log-likelihood ratios, corresponding to the users, and generating a plurality of decoded signals corresponding to the plurality of data signals according to the log-likelihood ratios.

### CROSS REFERENCE TO RELATED APPLICATIONS

This application claims the benefit of U.S. provisional application No. 62/261,892, filed on Dec. 2, 2015 and U.S. provisional application No. 62/355,320, filed on Jun. 27, 2016, which is incorporated herein by reference.

### BACKGROUND OF THE INVENTION

1. Field of the Invention

The present invention relates to a multiple access system in which some users can share the same signature by using a method for the receiving device to differentiate signals from multiple users using the same signature, and more particularly, to a system with receiving devices capable of differentiating signals from multiple users which use a common signature.

2. Description of the Prior Art

In the multiple access communication system, such as the code-division multiple access (CDMA) system and the interleaver-division multiple access (IDMA) system, each user employs a unique signature for transmission and the receiver can recover the message of each user through the unique signature. However, the number of signatures in the multiple-access communication system may be limited. For example, in the CDMA system, the signature is a spreading code, and the number of distinct spreading codes is limited by a spreading code length. In the IDMA system, the signature is its interleaver, and the number of distinct interleavers is limited by the interleaver size. In such a situation, the number of users in the multiple access communication system (either in the IDMA system or in the CDMA system) is limited if a unique signature for each user is required.

Therefore, it is necessary to improve the prior art.

### SUMMARY OF THE INVENTION

It is therefore a primary objective of the present invention to provide a system in which receiving devices employing a method to improve over disadvantages of the prior art.

An embodiment of the present invention discloses a multiple access communication system in which receiving devices equipped with a method of differentiating signals from multiple users assigned with the same signature, the method comprising steps of determining a plurality of hypothetical signal levels according to a plurality of channel information; obtaining a pre-processed signal according to a received signal received by the receiving device, wherein the pre-processed signal comprises a mixture of a plurality of transmitted signals from the plurality of transmitting devices, and the plurality of transmitted signals are generated according to a plurality of signatures and encoded according to a plurality of data signals; calculating a plurality of preliminary symbol-level probabilities according to the pre-processed signal and the hypothetical signal levels, wherein the number of signatures may be less than the number of users; obtaining a plurality of log-likelihood ratios (or the associated bit-level probabilities), corresponding to the plurality of users, and generating a plurality of detected/decoded signals corresponding to the plurality of data signals according to the plurality of log-likelihood ratios.

An embodiment of the present invention further discloses a receiving device comprising a multilevel detection unit, configured to perform steps of determining a plurality of hypothetical signal levels according to a plurality of channel information; obtaining a pre-processed signal according to a received signal received by the receiving device, wherein the pre-processed signal comprises a mixture of a plurality of transmitted signals from the plurality of transmitting devices, and the plurality of transmitted signals are generated according to a plurality of signatures and encoded according to a plurality of data signals; calculating a plurality of preliminary symbol-level probabilities according to the pre-processed signal and the hypothetical signal levels, wherein the number of signatures may be less than the number of users; obtaining a plurality of log-likelihood ratios (or the associated bit-level probabilities), corresponding to the plurality of users, and generating a plurality of detected/decoded signals corresponding to the plurality of data signals according to the plurality of log-likelihood ratios.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multiple access communication system according to an embodiment of the present invention.

FIG. 2 is a schematic diagram of a decoding process according to an embodiment of the present invention.

FIG. 3 is a schematic diagram of a multiple access communication system according to an embodiment of the present invention.

FIG. 4 is a schematic diagram of a decoding process according to an embodiment of the present invention.

FIG. 5 is a schematic diagram of a multiple access communication system according to an embodiment of the present invention.

FIG. 6 is a schematic diagram of a decoding process according to an embodiment of the present invention.

FIG. 7 illustrates performance curves of bit error rate for the multiple access communication systems of the present invention.

FIG. 8 illustrates performance curves of bit error rate for the multiple access communication systems of the present invention.

### DETAILED DESCRIPTION

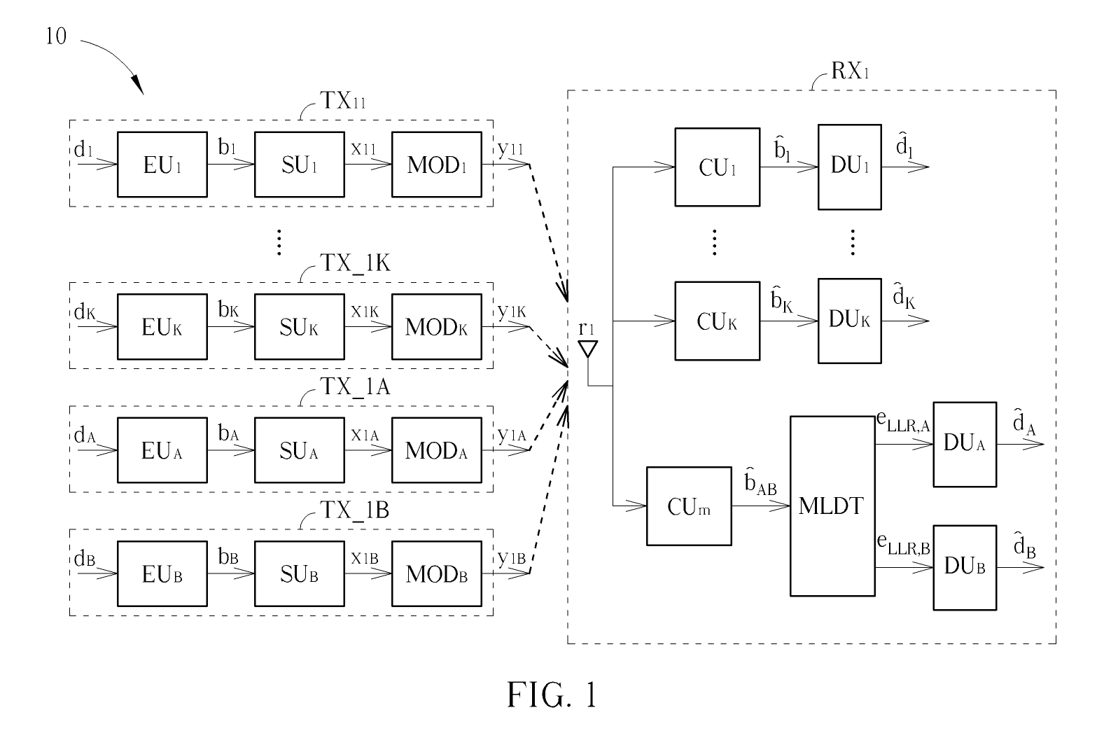

Please refer to FIG. 1, which is a schematic diagram of a multiple access communication system 10 according to an embodiment of the present invention. The multiple access communication system 10 is a code-division multiple access (CDMA) system. The multiple access communication system 10 comprises a receiving device RX₁ and a plurality of transmitting devices TX₁₁, . . . , TX_{1K}, TX_{1A} and TX_{1B}. The transmitting device TX₁ₖ comprises an encoding unit EDₖ, a spreading unit SUₖ and a modulation unit MODₖ, where k represents a user index ranging from 1 to K. Similarly, the transmitting device TX_{1A} comprises an encoding unit ED_{A}, a spreading unit SU_{A} and a modulation unit MOD_{A}, and the transmitting device TX_{1B} comprises an encoding unit ED_{B}, a spreading unit SU_{B} and a modulation unit MOD_{B}. The receiving device RX₁ comprises correlating units CU₁, . . . , CU_{K}, a correlating unit CUₘ, decoding units DU₁, . . . , DU_{K}, a decoding unit DU_{A}, a decoding unit DU_{B}, and a multilevel detection unit MLDT.

Among the transmitting devices TX₁₁, . . . , TX_{1K}, each transmitting device is assigned with a unique spreading code as a signature for differentiating different users at the receiving device RX₁. In other words, the spreading units SU₁, . . . , SU_{K} utilize different spreading codes s₁, . . . , s_{K} to generate spread signals x₁₁, . . . , x_{1K}. At the receiving device RX₁, the correlating units CU₁, . . . , CU_{K} are configured to correlate a received signal r₁ with the spreading codes s₁, . . . , sₓ, such that estimated signals \hat{b}₁, . . . , \hat{b}_{K} are generated and the decoding units DU₁, . . . , DU_{K} may generate decoded signals \hat{d}₁, . . . , \hat{d}_{K} according to the estimated signals \hat{b}₁, . . . , \hat{b}_{K}. The decoded signals \hat{d}₁, . . . , \hat{d}_{K} are corresponding to data signals d₁, . . . , d_{K} of the transmitting devices TX₁₁, . . . , TX_{1K}, and the estimated signals \hat{b}₁, . . . , \hat{b}_{K} are corresponding to encoded signal b₁, . . . , b_{K}, which are encoded by encoding units EU₁, . . . , EU_{K}, where the encoding units EU₁, . . . , EU_{K} may be forward error correction (FEC) encoder.

In addition, the spreading units SU_{A} and SU_{B} utilize another spreading code sₘ to generate spread signals x_{1A} and x_{1B}. Note that, the spreading units SU_{A} and SU_{B} use the same spreading code (i.e., sₘ) to generate the spread signals x_{1A} and x_{1B}. At the receiving device RX₁, the correlating unit CUₘ is configured to correlate the received signal r₁ with the spreading code sₘ, to generate a pre-processed signal \hat{b}_{AB}. To differentiate data signals d_{A} and d_{B} from the transmitting device TX_{1A} and TX_{1B}, the multilevel detection unit MLDT is configured to generate a set of preliminary symbol-level probabilities {p_{q}} and log-likelihood ratios (LLRs) e_{LLR,A} and e_{LLR,B} corresponding to a user A and a user B according to the pre-processed signal \hat{b}_{AB}, and the decoding unit DU_{A} is configured to generate a decoded signal \hat{d}_{A} corresponding to the data signal d_{A} of the transmitting device TX_{1A}, and the decoding unit DU_{B} is configured to generate a decoded signal \hat{d}_{B} corresponding to the data signal d_{B} of the transmitting device TX_{1B}, such that the data signals d_{A} and d_{B} of the transmitting device TX_{1A} (user A) and the transmitting device TX_{1B} (user B) are differentiated and successfully decoded at the receiving device RX₁.

The received signal r₁ at the receiving device RX₁ may be expressed as

$${r}_{1} = {\sum }_{k = 1}^{K} {h}_{k} {y}_{1 k} + {h}_{A} {y}_{1 A} + {h}_{B} {y}_{1 B} + w ,$$

where w represents a Gaussian noise with variance σ², signals y₁₁, . . . , y_{1K}, y_{1A} and y_{1B} represent transmitted signals transmitted by the transmitting devices TX₁₁, . . . , TX_{1K}, TX_{1A}, TX_{1B}, and h₁, . . . , h_{K}, h_{A} and h_{B} represent channel coefficients between the receiving device RX₁ and the transmitting devices TX₁₁, . . . , TX_{1K}, TX_{1A}, TX_{1B}. More specifically, for the j^{th} chip, the received signal r₁(j) may be expressed as

$${r}_{1} ( j ) = {\sum }_{k = 1}^{K} {h}_{k} {y}_{1 k} ( j ) + {h}_{A} {y}_{1 A} ( j ) + {h}_{B} {y}_{1 B} ( j ) + w ( j ) .$$

In addition, the transmitted signals y₁₁, . . . , y_{1K} are generated according to the spreading codes s₁, . . . , s_{K}, and the transmitted signals y_{1A} and y_{1B} are generated according to the spreading code sₘ. Note that, the spreading codes s₁, . . . , s_{K} and sₘ are orthogonal to each other or are correlated with each other with low correlation. Therefore, after the correlating unit CUₘ correlates the received signal r₁ with the spreading code sₘ, the term

$${\sum }_{k = 1}^{K} {h}_{k} {y}_{1 k}$$

would be significantly eliminated, and the pre-processed signal \hat{b}_{AB} may be expressed as \hat{b}_{AB}=h_{A}y_{1A}+h_{B}y_{1B}+n_{AB}, where n_{AB} is related to the Gaussian noise w and the remaining interference from

$${\sum }_{k = 1}^{K} {h}_{k} {y}_{1 k} .$$

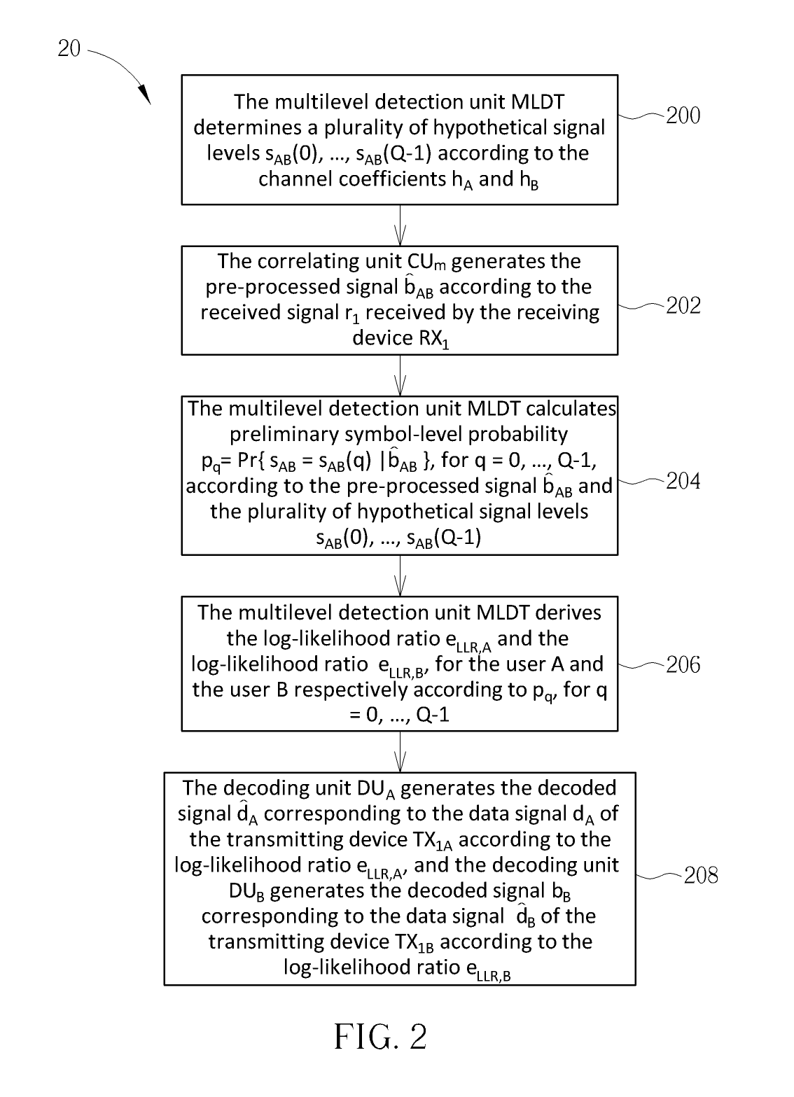

Please refer to FIG. 2, which is a schematic diagram of a detection/decoding process 20 according to an embodiment of the present invention. The detection/decoding process 20 is executed by the receiving device RX₁, to differentiate and successfully decode the data signals d_{A} and d_{B} as the decoded signals \hat{d}_{A} and \hat{d}_{B}. The decoding process 20 comprises following steps:

Step 200: The multilevel detection unit MLDT determines a plurality of hypothetical signal levels s_{AB}(0), . . . , s_{AB}(Q−1) according to the channel coefficients h_{A} and h_{B}.

Step 202: The correlating unit CUₘ generates the pre-processed signal \hat{b}_{AB} according to the received signal r₁ received by the receiving device RX₁.

Step 204: The multilevel detection unit MLDT calculates preliminary symbol-level probability p_{q}=Pr{s_{AB}=s_{AB}(q)|\hat{b}_{AB}}, for q=0, . . . , Q−1, according to the pre-processed signal \hat{b}_{AB} and the plurality of hypothetical signal levels s_{AB}(0), . . . , s_{AB}(Q−1).

Step 206: The multilevel detection unit MLDT derives the log-likelihood ratio e_{LLR,A} and the log-likelihood ratio e_{LLR,B}, for the user A and the user B respectively according to p_{q}, for q=0, . . . , Q−1.

Step 208: The decoding unit DU_{A} generates the decoded signal \hat{d}_{A} corresponding to the data signal d_{A} of the transmitting device TX_{1A} according to the log-likelihood ratio e_{LLR,A}, and the decoding unit DU_{B} generates the decoded signal \hat{d}_{B} corresponding to the data signal d_{B} of the transmitting device TX_{1B} according to the log-likelihood ratio e_{LLR,B}.

In Step 200, the multilevel detection unit MLDT determines the plurality of hypothetical signal levels s_{AB}(0), . . . , s_{AB}(Q−1), where Q is the number of the plurality of hypothetical signal levels s_{AB}(0), . . . , s_{AB}(Q−1), given that the channel coefficients h_{A} and h_{B} are known at the receiving device RX₁. That is, the availability of channel state information (CSI) for receiving device RX₁ is required. Here, the channel coefficients h_{A} and h_{B} are the required CSI. In the current embodiment, there are two transmitting devices (i.e., the transmitting devices TX_{1A} and TX_{1B}) in the multiple access communication system 10, which use the same signature (i.e., the spreading code sₘ) to generate their corresponding transmitted signals y_{1A} and y_{1B}. Since the pre-processed signal \hat{b}_{AB} may be expressed as \hat{b}_{AB}=h_{A}y_{1A}+h_{B}y_{1B}+n_{AB}, the MLDT may regard the pre-processed signal \hat{b}_{AB} as \hat{b}_{AB}=s_{AB}+n_{AB}, where the noise-free signal level s_{AB} may be expressed as s_{AB}=h_{A}y_{1A}+h_{B}y_{1B}, which will be used to constitute the hypothetical signal levels. In an embodiment, the transmitted signal y_{1A} and y_{1B} may be BPSK/2PAM modulated, which may imply that the transmitted signal y_{1A} is equal to 1 when the data signal b_{A} is 0, and the transmitted signal y_{1A} is equal to −1 when the data signal b_{A} is 1. Similarly, the transmitted signal y_{1B} is equal to 1 when the data signal b_{B} is 0, and the transmitted signal y_{1B} is equal to −1 when the data signal b_{B} is 1. Given that the channel coefficients h_{A} and h_{B} are known by the multilevel detection unit MLDT, in the current embodiment of two user using the same signature, there are four hypothetical signal levels, i.e., s_{AB}(0)=h_{A}+h_{B}, s_{AB}(1)=h_{A}−h_{B}, s_{AB}(2)=−h_{A}+h_{B}, and s_{AB}(3)=−h_{A}−h_{B}. Note that, Q=4.

Please refer to TABLE I, which lists different hypothetical signal levels s_{AB}(0), . . . , s_{AB}(Q−1) under different occasions. According to TABLE I, the multilevel detection unit MLDT hypothesizes that the hypothetical signal level s_{AB}(0) is h_{A}+h_{B} under an occasion that the data signal b_{A} of the user A is 0 and the data signal b_{B} of the user B is 0, hypothesizes that the hypothetical signal level s_{AB}(1) is h_{A}-h_{B} under an occasion that the data signal b_{A} of the user A is 0 and the data signal b_{B} of the user B is 1, hypothesizes that the hypothetical signal level s_{AB}(2) is −h_{A}+h_{B} under an occasion that the data signal b_{A} of the user A is 1 and the data signal b_{B} of the user B is 0, and hypothesizes that the hypothetical signal level s_{AB}(3) is −h_{A}−h_{B} under an occasion that the data signal b_{A} of the user A is 1 and the data signal b_{B} of the user B is 1.

TABLE I

| Occasion | | | y_{1A}/ | y_{1B}/ | |
|---|---|---|---|---|---|
| index q | b_{A} | b_{B} | y_{h, 1A} | y_{h, 1B} | s_{AB} (q) |
| 0 | 0 | 0 | +1 | +1 | h_{A} + h_{B} |
| 1 | 0 | 1 | +1 | −1 | h_{A} − h_{B} |
| 2 | 1 | 0 | −1 | +1 | −h_{A} + h_{B} |
| 3 | 1 | 1 | −1 | −1 | −h_{A} − h_{B} |

In Step 202, the correlating unit CUₘ generates the pre-processed signal \hat{b}_{AB} according to the received signal r₁ received by the receiving device RX₁. In other words, the correlating unit CUₘ correlates the received signal r₁ with the spreading code sₘ, which is to multiply the received signal r₁ by the spreading code sₘ and perform a summation over a code length SP, to generate the pre-processed signal \hat{b}_{AB}. Mathematically, the pre-processed signal \hat{b}_{AB} may be expressed as

$${\hat{b}}_{AB} = \frac{1}{SP} {\sum }_{j = 1}^{SP} {r}_{1} ( j ) {s}_{m} ( j ) .$$

Due to the low correlation properties among the spreading codes s₁-s_{K} and sₘ, the effect of

$${\sum }_{k = 1}^{K} {h}_{k} {y}_{1 k} ( j )$$

in \hat{b}_{AB} would be significantly reduced, and the pre-processed signal \hat{b}_{AB} would be expressed as \hat{b}_{AB}=h_{A}y_{1A}+h_{B}y_{1B}+n_{AB}, and n_{AB} may be assumed to be Gaussian distributed.

In Step 204, the multilevel detection unit MLDT calculates preliminary symbol-level probabilities p_{q}=Pr{s_{AB}=s_{AB}(q)|\hat{b}_{AB}}, for q=0, . . . , Q−1 according to the pre-processed signal \hat{b}_{AB} and the plurality of hypothetical signal levels s_{AB}(0), . . . , s_{AB}(Q−1) by assuming that s_{AB}(0), . . . , s_{AB}(Q−1) are equally likely before transmission. We also have

$${p}_{q} = Pr \{ {\hat{b}}_{AB} \vert {s}_{AB} = {s}_{AB} ( q ) \} \frac{Pr \{ {s}_{AB} = {s}_{AB} ( q ) \}}{Pr \{ {\hat{b}}_{AB} \}} .$$

By assuming that s_{AB}(0), . . . , s_{AB}(Q−1) are equally likely, the term

$$\frac{Pr \{ {s}_{AB} = {s}_{AB} ( q ) \}}{Pr \{ {\hat{b}}_{AB} \}}$$

may be modeled as a constant C. Hence, p_{q} may be calculated by p_{q}=C Pr{\hat{b}_{AB}|s_{AB}=s_{AB}(q)}. Assume that n_{AB} is a zero-mean Gaussian random variable with variance σ_{SP}²=σ²/Sp, we have

$$Pr \{ {\hat{b}}_{AB} \vert {s}_{AB} = {s}_{AB} ( q ) \} = \frac{1}{\sqrt{2 {πσ}_{SP}^{2}}} exp ( - \frac{{\vert {\hat{b}}_{AB} - {s}_{AB} ( q ) \vert}^{2}}{2 {σ}_{SP}^{2}} ) .$$

In addition, the constant C is determined to satisfy that

$${\sum }_{q = 0}^{Q - 1} {p}_{q} = 1$$

in general. Therefore, in the current embodiment, the MLDT calculates the preliminary symbol-level probabilities p₀, . . . , p₃ of the hypothetical signal levels s_{AB}(0), . . . , s_{AB}(3).

In Step 206, after the symbol-level probabilities p₀, . . . , P₃ are obtained, the MLDT is able derive the bit-level probabilities Pr{b_{A}=0|\hat{b}_{AB}}, Pr{b_{A}=1|\hat{b}_{AB}}, Pr{b_{B}=0|\hat{b}_{AB}}, Pr{b_{B}=1|\hat{b}_{AB}} for users A and B respectively, where

Pr{b_{A}=0|\hat{b}_{AB}}=Pr{s_{AB}=s_{AB}(0)|\hat{b}_{AB}}+Pr{s_{AB}=s_{AB}(1)|\hat{b}_{AB}}=p₀+p₁,

Pr{b_{A}=1|\hat{b}_{AB}}=Pr{s_{AB}=s_{AB}(2)|\hat{b}_{AB}}+Pr{s_{AB}=s_{AB}(3)|\hat{b}_{AB}}=p₂+p₃,

Pr{b_{B}=0|\hat{b}_{AB}}=Pr{s_{AB}=s_{AB}(0)|\hat{b}_{AB}}+Pr{s_{AB}=s_{AB}(2)|\hat{b}_{AB}}=p₀+p₂, and

Pr{b_{B}=1|\hat{b}_{AB}}=Pr{s_{AB}=s_{AB}(1)|\hat{b}_{AB}}+Pr{s_{AB}=s_{AB}(3)|\hat{b}_{AB}}=p₁+p₃.

With the bit-level probability Pr{b_{A}=0|\hat{b}_{AB}}, Pr{b_{A}=1|\hat{b}_{AB}}, Pr{b_{B}=0|\hat{b}_{AB}} and Pr{b_{B}=1|\hat{b}_{AB}}, the log-likelihood ratios e_{LLR,A} and e_{LLR,B} can be computed as

$${e}_{LLR , A} = ln \frac{Pr \{ {b}_{A} = 0 \vert {\hat{b}}_{AB} \}}{Pr \{ {b}_{A} = 1 \vert {\hat{b}}_{AB} \}} = \frac{{p}_{0} + {p}_{1}}{{p}_{2} + {p}_{3}} and$$

$${e}_{LLR , B} = ln \frac{Pr \{ {b}_{B} = 0 \vert {\hat{b}}_{AB} \}}{Pr \{ {b}_{B} = 1 \vert {\hat{b}}_{AB} \}} = \frac{{p}_{0} + {p}_{2}}{{p}_{1} + {p}_{3}} ,$$

respectively. After the log-likelihood ratios e_{LLR,A} and e_{LLR,B} are obtained, the MLDT may deliver the log-likelihood ratios e_{LLR,A} and e_{LLR,B} to the decoding units DU_{A} and DU_{B}.

In Step 208, the decoding unit DU_{A} generates the decoded signal \hat{d}_{A} corresponding to data signal d_{A} of the transmitting device TX_{1A}, and the decoding unit DU_{B} generates the decoded signal \hat{d}_{B} corresponding to the data signal d_{B} of the transmitting device TX_{1B}. The decoding units DU_{A} and DU_{B} may use any decoding method to generate the decoded signals \hat{d}_{A} and \hat{d}_{B}.

In the conventional CDMA system, transmitted signals from users/transmitting devices using the same signature/spreading code are not able to be differentiated and decoded. In comparison, the present invention utilizes the multilevel detection unit MLDT to compute the log-likelihood ratios corresponding to the users/transmitting devices which utilize the same signature/spreading code to generate the transmitted signals, such that the data signals of those users may be differentiated and successfully decoded. Therefore, the user capacity of the multiple access communication system of the present invention, i.e., the number of users capable of simultaneously operating in the multiple access communication system of the present invention can be significantly increased. For a user which has a unique signature, its detection/decoding can be implemented by using an MLDT with one of the two channel coefficients being set to zero. The user assigned with a unique signature is a degenerate case of multiple users assigned with the same signature. Hence, the MLDT units can be applied to all users.

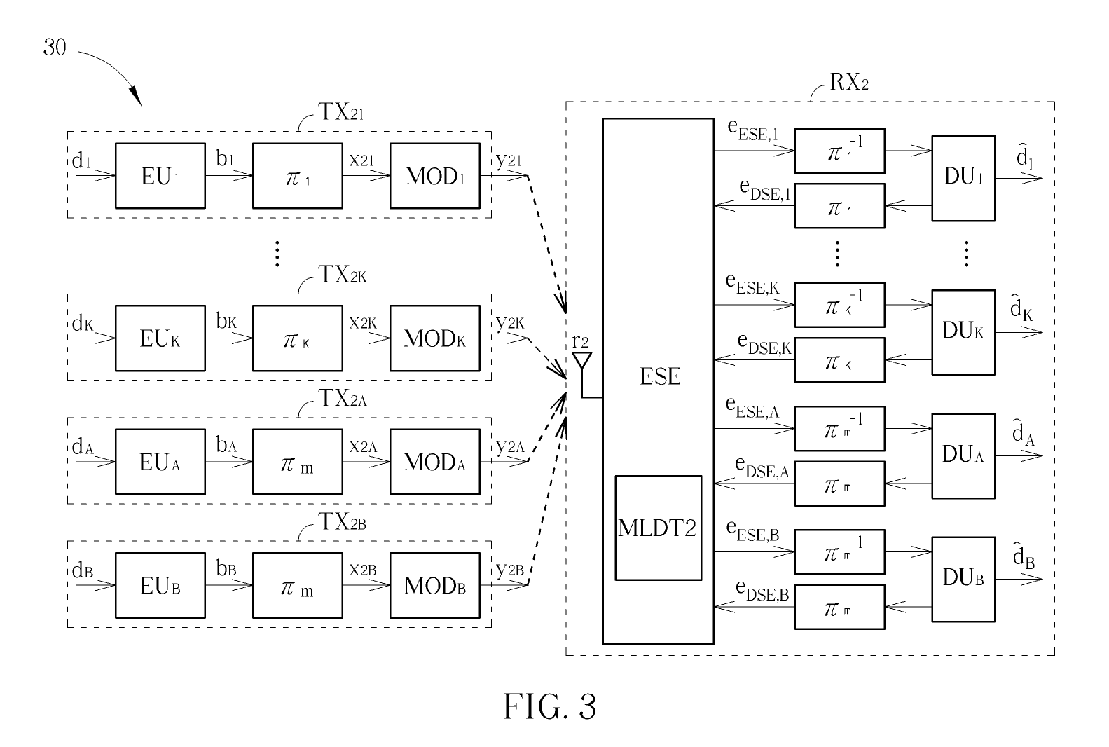

Notably, the multiple access communication system of the present invention is not limited to be a CDMA system. Please refer to FIG. 3, which is a schematic diagram of a multiple access communication system 30 according to an embodiment of the present invention. The multiple access communication system 30 is an interleave-division multiple access (IDMA) system. Details of IDMA can be referred to L. Ping, L, Liu, K. Wu, and W. K. Leung, “Interleave-division multiple access,” IEEE Trans. Wireless Commun., vol. 5, pp. 938-947, April 2006. Similarly, the multiple access communication system 30 comprises a receiving device RX₂ RX₂ and a plurality of transmitting devices TX₂₁, . . . , TX_{2K}, TX_{2A} and TX_{2B}. The transmitting device TX₂ₖ comprises an encoding unit EDₖ, an interleaver πₖ and a modulation unit MODₖ, where k also represents a user index ranging from 1 to K. The transmitting device TX_{2A} comprises an encoding unit ED_{A}, an interleaver πₘ and a modulation unit MOD_{A}, and the transmitting device TX_{2B} comprises an encoding unit ED_{B}, the interleaver πₘ and a modulation unit MOD_{B}. The receiving device RX₂ comprises the interleavers π₁, . . . , π_{K} and πₘ, deinterleavers π₁⁻¹, . . . , π_{K}⁻¹ and πₘ⁻¹, the decoding units DU₁-DU_{K}, DU_{A} and DU_{B}, and an elementary signal estimator ESE. The detection/decoding operation for RX₂ is operated in an iterative manner. The elementary signal estimator ESE comprises a multilevel detection unit MLDT2 for differentiating signals from the user A and the user B using the same interleaver (i.e., the same signature).

Among the transmitting devices TX₂₁, . . . , TX_{2K}, each transmitting device is assigned with a unique interleaver as a signature for differentiating different users at the receiving device RX₂, i.e., the transmitting devices TX₂₁, . . . , TX_{2K} utilize different interleavers π₁, . . . , π_{K} to generate interleaved signals x₂₁, . . . , x_{2K}. The receiving device RX₂ utilizes an iteratively decoding serial schedule method, which employs the elementary signal estimator ESE, the interleavers π₁, . . . , π_{K} and the deinterleavers π₁⁻¹, . . . , π_{K}⁻¹, to generate the decoded signals \hat{d}₁, . . . , \hat{d}_{K}.

In addition, the transmitting devices TX_{2A} and TX_{2B} utilize the same interleaver πₘ to generate interleaved signals x_{2A} and x_{2B}. Similarly, the multilevel detection unit MLDT2 is configured to generate the symbol-level probability p₀, p₁, p₂, and p₃, which are used to generate log-likelihood ratios e_{ESE,A} and e_{ESE,B} corresponding to the user A and the user B according to a pre-processed signal z_{AB}, such that the data signals d_{A} and d_{B} of the user A and the user B are differentiated and successfully decoded at the receiving device RX₂.

The received signal r₂ at the receiving device RX₂ may be expressed as

$${r}_{2} = {\sum }_{k = 1}^{K} {h}_{k} {y}_{2 k} + {h}_{A} {y}_{2 A} + {h}_{B} {y}_{2 B} + w ,$$

where signals y₂₁, . . . , y_{2K}, y_{2A} and y_{2B} represent transmitted signals transmitted by the transmitting devices TX₂₁, . . . , TX_{2K}, TX_{2A} and TX_{2B}, and h₁, . . . , h_{K}, h_{A} and h_{B} also represent channel coefficients between the receiving device RX₂ and the transmitting devices TX₂₁, . . . , TX_{2K}, TX_{2A} and TX_{2B}. Note that, the received signal r₂ may be rewritten as r₂=h_{A}y_{2A}+h_{B}y_{2B}+ζ_{AB}, where

$${ζ}_{AB} = {\sum }_{k = 1}^{K} {h}_{k} {y}_{2 k} + w$$

is summation of the interference from other users and the additive noise, and ζ_{AB} is assumed to be Gaussian distributed. The elementary signal estimator ESE may generate a pre-processed signal z_{AB} as z_{AB}=r₂−E(ζ_{AB}), where E(•) is an expectation operator, and E(ζ_{AB}), may be regarded as an estimated interference-plus-noise level. Thus, the pre-processed signal z_{AB} is a noise-corrupted version of the signal level s_{AB,2}, where s_{AB,2}=h_{A}y_{2A}+h_{B}y_{2B}. The elementary signal estimator ESE also generate a pre-processed signal z₂ₖ as z₂ₖ=r₂−E(ζ₂ₖ) where ζ_{AB}=Σi≠h₂ᵢy₂ᵢ+h_{A}y_{2A}+h_{B}y_{2B}+w. The pre-processed signal z₂ₖ noise-corrupted version of the signal level s₂ₖ=h₂ₖ y₂ₖ.

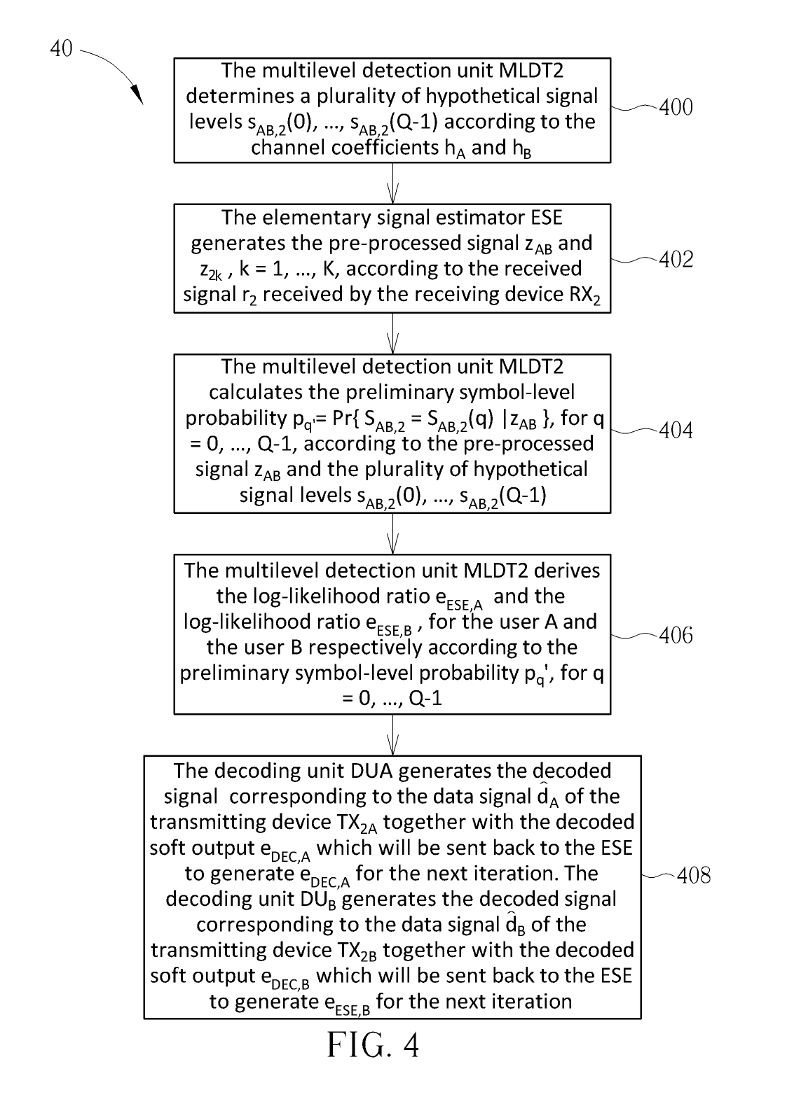

Please refer to FIG. 4, which is a schematic diagram of a decoding process 40 according to an embodiment of the present invention. The decoding process 40 is executed by the receiving device RX₂, to differentiate and successfully decode the data signals d_{A} and d_{B} as the decoded signals \hat{d}_{A} and \hat{d}_{B}. The decoding process 40 comprises following steps:

Step 400: The multilevel detection unit MLDT2 determines a plurality of hypothetical signal levels s_{AB,2}(0), . . . , s_{AB,2}(Q−1) according to the channel coefficients h_{A} and h_{B}.

Step 402: The elementary signal estimator ESE generates the pre-processed signal z_{AB} and z₂ₖ, k=1, . . . , K, according to the received signal r₂ received by the receiving device RX₂.

Step 404: The multilevel detection unit MLDT2 calculates the preliminary symbol-level probability p_{q′}=Pr{s_{AB,2}=s_{AB,2}(q)|z_{AB}}, for q=0, . . . , Q−1, according to the pre-processed signal z_{AB} and the plurality of hypothetical signal levels s_{AB,2}(0), . . . , s_{AB,2}(Q−1).

Step 406: The multilevel detection unit MLDT2 derives the log-likelihood ratio e_{ESE,A} and the log-likelihood ratio e_{ESE,B} for the user A and the user B respectively according to the preliminary symbol-level probability p_{q}′, for q=0, . . . , Q−1.

Step 408: The decoding unit DU_{A} generates the decoded signal \hat{d}_{A} corresponding to the data signal d_{A} of the transmitting device TX_{2A} together with the decoded soft output e_{DEC,A} which will be sent back to the ESE to generate e_{ESE,A} for the next iteration. The decoding unit DU_{B} generates the decoded signal \hat{d}_{B} corresponding to the data signal d_{B} of the transmitting device TX_{2B} together with the decoded soft output e_{DEC,B} which will be sent back to the ESE to generate e_{ESE,B} for the next iteration.

In Step 400, the multilevel detection unit MLDT2 utilizes TABLE II to determine plurality of hypothetical signal levels s_{AB,2}(0), . . . , s_{AB,2}(Q−1). Again, the multilevel detection unit MLDT2 hypothesizes that the hypothetical signal level s_{AB,2}(0) is h_{A}+h_{B} under an occasion that the interleaved signal x_{2A} of the user A is 0 and the interleaved signal x_{2B} of the user B is 0, hypothesizes that the hypothetical signal level s_{AB,2}(1) is h_{A}−h_{B} under an occasion that the interleaved signal x_{2A} of the user A is 0 and the interleaved signal x_{2B} of the user B is 1, hypothesizes that the hypothetical signal level s_{AB,2}(2) is −h_{A}+h_{B} under an occasion that the interleaved signal x_{2A} of the user A is 1 and the interleaved signal x_{2B} of the user B is 0, and hypothesizes that the hypothetical signal level s_{AB,2}(3) is −h_{A}−h_{B} under an occasion that the interleaved signal x_{2A} of the user A is 1 and the interleaved signal x_{2B} of the user B is 1. In addition, the hypothetical transmitted signal y_{h,2A}(y_{h,2B}) being +1 means that the transmitted signal y_{2A} (y_{2B}) is hypothesized to be +1, and the hypothetical transmitted signal y_{h,2A} (y_{h,2B}) being −1 means that the transmitted signal y_{2A} (y_{2B}) is hypothesized to be −1.

TABLE II

| Occasion | | | y_{2A}/ | y_{2B}/ | |
|---|---|---|---|---|---|
| index q | x_{2A} | x_{2B} | y_{h, 2A} | y_{h, 2B} | s_{AB, 2} (q) |
| 0 | 0 | 0 | +1 | +1 | h_{A} + h_{B} |
| 1 | 0 | 1 | +1 | −1 | h_{A} − h_{B} |
| 2 | 1 | 0 | −1 | +1 | −h_{A} + h_{B} |
| 3 | 1 | 1 | −1 | −1 | −h_{A} − h_{B} |

In Step 402, the elementary signal estimator ESE generates the pre-processed signal z_{AB} according to the received signal r₂ received by the receiving device RX₂. We may express E(ζ_{AB}) as E(ζ_{AB})=E(r₂)−h_{A}E(y_{2A})−h_{B}E (y_{2B})=Σₖ₌₁^{K}h₂ₖE(y₂ₖ), where E(y₂ₖ) is set to zero in the first iteration and set to tan h(e_{DEE}(x₂ₖ)/2) in the following iterations which can be obtained from the soft output of DUₖ.

In Step 404, the preliminary symbol-level probability p_{q}′=Pr{s_{AB,2}=s_{AB,2}(q)|z_{AB}}, q=0, . . . , Q−1 is calculated by p_{q}′=Pr{z_{AB}|s_{AB,2}=s_{AB,2}(q)}Pr{s_{AB,2}=s_{AB,2}(q)}/Pr{z_{AB}}. By assuming that s_{AB,2}(0), . . . , s_{AB,2}(Q−1) are equally likely, the term Pr{s_{AB,2}=s_{AB,2}(q)}/Pr{z_{AB}} may be modeled as a constant C. Hence, p_{q}′ may be calculated by p_{q}′=CPr{z_{AB}|s_{AB,2}=s_{AB,2}(q)}, where

$$Pr \{ {z}_{AB} \vert {s}_{AB , 2} = {s}_{AB , 2} ( q ) \} = \frac{1}{\sqrt{2 {πVar}_{\{ {ζ}_{AB} \}}}} exp ( - \frac{{\vert {z}_{AB} - {s}_{AB , 2} ( q ) \vert}^{2}}{2 {Var}_{\{ {ζ}_{AB} \}}} ) ,$$

wherein Var{ζ_{AB}}=Σₖ₌₁^{K}<|h₂ₖ|²Var(y₂ₖ)+σ² and Var(y₂ₖ)=1−E(y₂ₖ)².

In Step 406, the multilevel detection unit MLDT2 calculates the log-likelihood ratio e_{ESE,A} as e_{ESE,A}=ln [Pr{x_{2A}=0|z_{AB}}/Pr{x_{2A}=1|z_{AB}}]=[p₀′+p₁′]/[p₂′+p₃′] and the log-likelihood ratio e_{ESE,B} as e_{ESE,B}=ln [Pr{x_{2B}=0|z_{AB}}/Pr{x_{2B}=1|z_{AB}}]=[p₀′+p₂′]/[p₁′+p₃]. Note that, Pr{x_{2A}=0|z_{AB}}, Pr{x_{2A}=1|z_{AB}}, Pr{x_{2B}=0|z_{AB}}, and Pr{x_{2A}=1|z_{AB}} are bit-level probabilities, and p₀′, . . . , p₃′ are symbol-level probabilities. The ESE may also calculate e_{ESE,k}, k=1, . . . , K.

Note that, in Steps 402 to 408, the iterative decoding for user 1, . . . , K and user A and user B are processed in a parallel manner, and not limited herein. The iterative decoding may be processed in a serial manner by which the soft output of some of DU₁, . . . , DU_{K} and DU_{A} and DU_{B} already generated within a certain iteration can be used for other users in the same iteration.

According to the detection/decoding process 40, the receiving device RX₂ in the multiple access communication system 30 is able to differentiate and successfully decode the data signals from different transmitting device/users, which utilize the same interleaver to generate their transmitted signals.

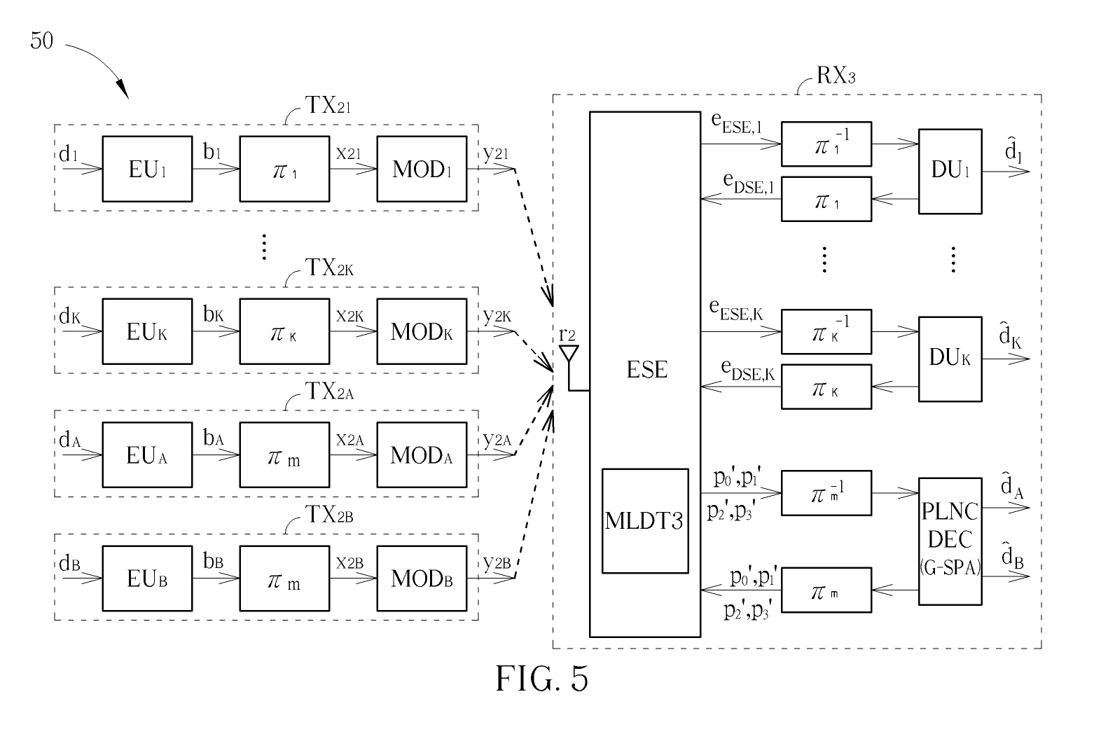

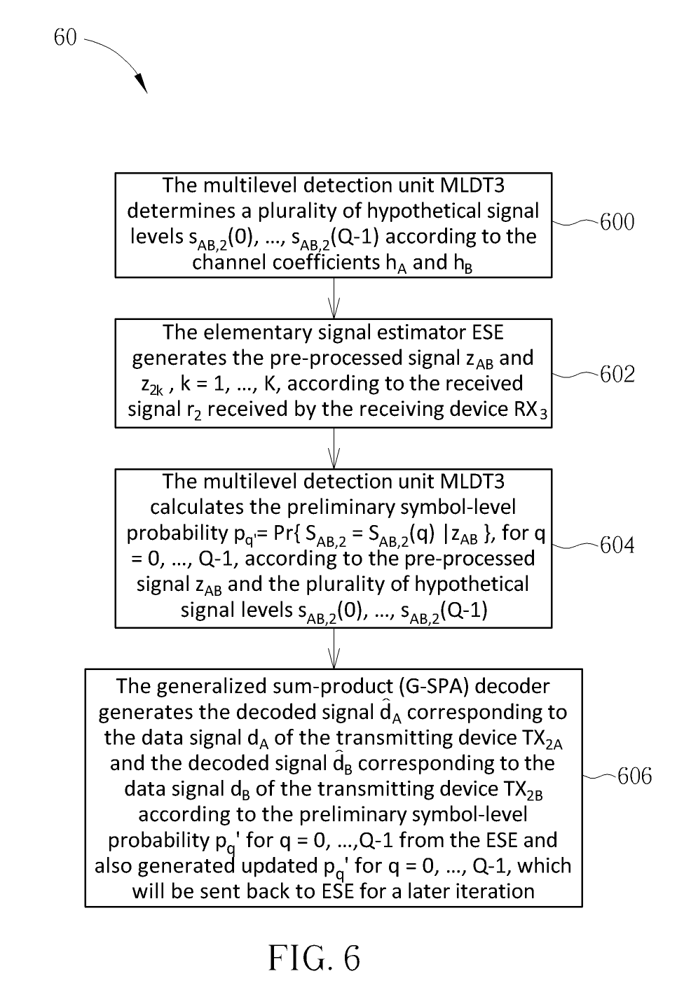

The system 30 and detection/decoding process 40 can be modified to a multiple access communication system 50 and a detection/decoding process 60. Please refer to FIG. 5 and FIG. 6, which are schematic diagrams of the multiple access communication system 50 and the detection/decoding process 60, respectively, according to an embodiment of the present invention. The decoding process 60 is executed by a receiving device RX₃ within the multiple access communication system 50, to differentiate and successfully decode the data signals d_{A} and d_{B} as the decoded signals \hat{d}_{A} and \hat{d}_{B}, where the receiving device RX₃ comprises a multilevel detection unit MLDT3. The detection/decoding process 60 as shown in FIG. 6 comprises following steps:

Step 600: The multilevel detection unit MLDT3 determines a plurality of hypothetical signal levels s_{AB,2}(0), . . . , s_{AB,2}(Q−1) according to the channel coefficients h_{A} and h_{B}.

Step 602: The elementary signal estimator ESE generates the pre-processed signal z_{AB} and z₂ₖ, k=1, . . . , K, according to the received signal r₂ received by the receiving device RX₃.

Step 604: The multilevel detection unit MLDT3 calculates the preliminary symbol-level probability p_{q}′=Pr{S_{AB,2}=S_{AB,2}(q)|z_{AB}}, for q=0, . . . , Q−1, according to the pre-processed signal z_{AB} and the plurality of hypothetical signal levels s_{AB,2}(0), . . . , s_{AB,2}(Q−1).

Step 606: The generalized sum-product (G-SPA) decoder generates the decoded signal \hat{d}_{A} corresponding to the data signal d_{A} of the transmitting device TX_{2A} and the decoded signal \hat{d}_{B} corresponding to the data signal d_{B} of the transmitting device TX_{2B} according to the preliminary symbol-level probability p_{q}′ for q=0, . . . , Q−1 from the ESE and also generated updated p_{q}′ for q=0, . . . , Q−1, which will be sent back to ESE for a later iteration.

The generalized sum-product (G-SPA) decoder is known by those skilled in the art. Readers may be referred to D. Wubben and Y. Lang, “Generalized sum-product algorithm for joint channel decoding and physical-layer network coding in two-way relay systems,” Global Telecommunication Conference (GLOBECOM 2010), December 2010, which is not narrated herein for brevity. Other details of the detection/decoding process 60 is similar to the detection/decoding process 60, which is not narrated herein as well.

Notably, the embodiments stated in the above are utilized for illustrating the concept of the present invention. Those skilled in the art may make modifications and alternations accordingly, and not limited herein. For example, in the multiple access communication systems 10 and 30, a number of users/transmitting devices using the same signature (either spreading code or interleaver) is two, which is not limited. The multiple access communication systems may accommodate more than two users/transmitting devices which use one single signature to generate their transmitted signals. Moreover, suppose that the multiple access communication system of the present invention owns N distinct signatures, and each signature is shared by M users/transmitting devices. Therefore, a total number of users/transmitting devices accommodated in the multiple access communication systems is N*M.

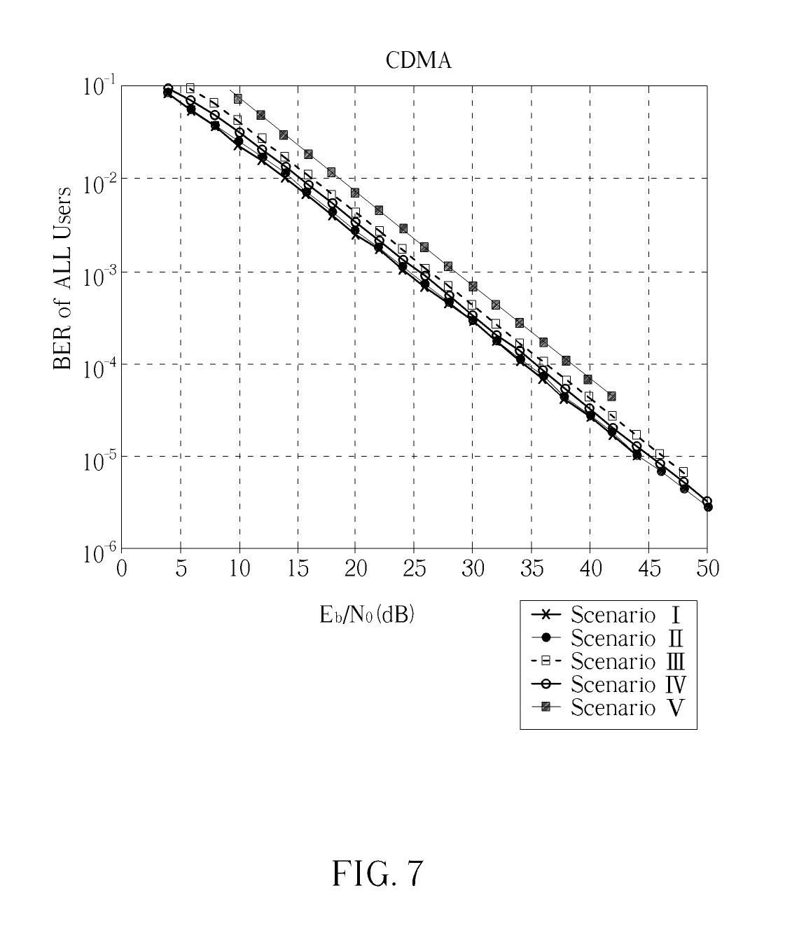

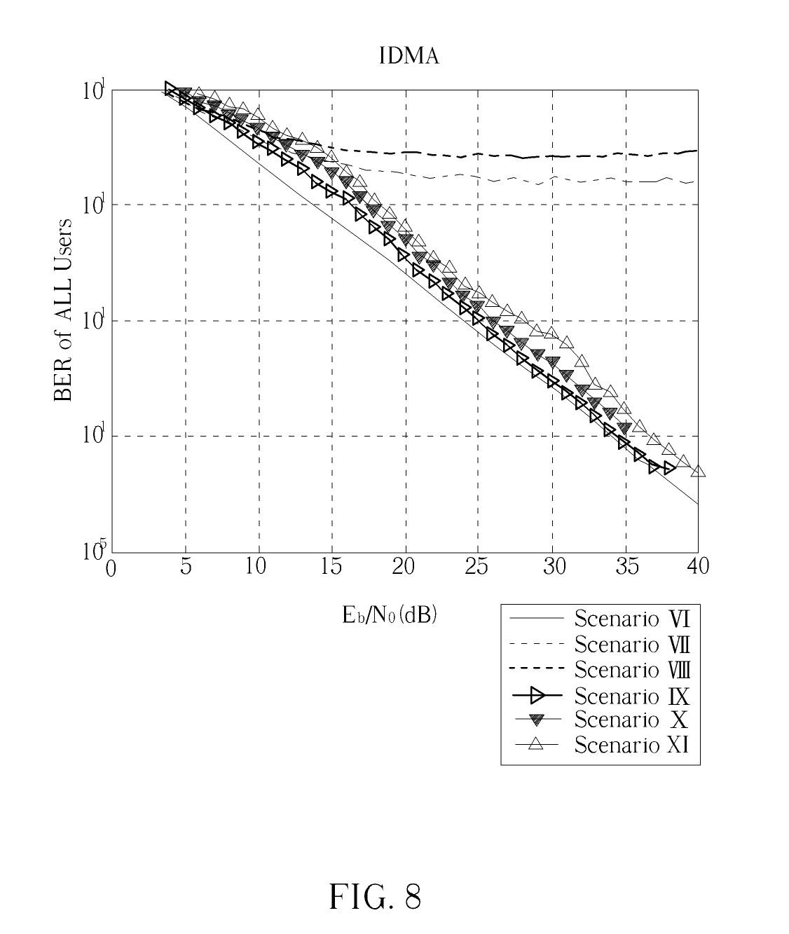

Please refer to FIG. 7 and FIG. 8, which illustrate performance curves of bit error rate (BER) over the block Rayleigh fading channels for the multiple access communication systems of the present invention. In FIG. 7, the multiple access communication system is the CDMA system with 16 distinct spreading codes (i.e., the code length SP=16). Scenario I represents that there are 16 users in the CDMA system and each user occupies one spreading code, which is equivalent to the conventional CDMA system. Scenario II represents that there are 17 users in the CDMA system and 2 of the 17 users share one spreading code. Scenario III represents that there are 32 users in the CDMA system and each spreading code (of the 16 distinct spreading codes) is shared by 2 users. Scenario IV represents that there are 18 users in the CDMA system and 3 of the 18 users share one spreading code. Scenario V represents that there are 48 users in the CDMA system and each spreading code is shared by 3 users. In FIG. 8, the multiple access communication system is the IDMA system with 16 distinct interleavers. Scenario VI represents that there are 16 users in the IDMA system and each user occupies one interleaver, which is equivalent to the conventional IDMA system. Scenarios VII and IX represent that there are 17 users in the IDMA system and 2 of the 17 users utilize a same interleaver. Scenarios VIII and X represent that there are 18 users in the IDMA system and 4 of the 18 users utilize 2 shared interleavers (each shared interleaver is utilized by 2 users). Scenario XI represents that there are 19 users in the IDMA system and 6 of the 19 users utilize 3 shared interleavers (each shared interleaver is utilized by 2 users). Note that, in scenarios VII and VIII, the receiving device does not use the decoding process of the present invention to differentiate and decode signals. In scenarios II, III, IV, V, IX, X and XI, the receiving device does use the decoding process of the present invention to differentiate and decode signals. As can be seen from FIG. 7 and FIG. 8, the BER performance of the receiving device using the decoding process of the present invention is comparable with conventional CDMA/IDMA receiver, given that the total number of users is significantly increased. In addition, as the receiving device does not use the decoding process of the present invention, the BER performance is seriously degraded.

In summary, when the receiving device utilizes the decoding process of the present invention, the data signals of multiple users/transmitting device is able to be differentiated and successfully detected/decoded. Compared to the prior art, the multiple access system may accommodate more users, and the user capacity of the multiple access system is enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of differentiating signals from multiple users, utilized in a receiving device within a multiple access communication system, method of differentiating signals from multiple users assigned with the same signature, the method comprising steps of
determining a plurality of hypothetical signal levels according to a plurality of channel information;
obtaining a pre-processed signal according to a received signal received by the receiving device, wherein the pre-processed signal comprises a mixture of a plurality of transmitted signals from the plurality of transmitting devices, and the plurality of transmitted signals are generated according to a plurality of signatures and encoded according to a plurality of data signals;
calculating a plurality of symbol-level probabilities according to the pre-processed signal and the hypothetical signal levels, wherein the number of signatures is less than the number of users;
obtaining a plurality of log-likelihood ratios corresponding to the plurality of users, and generating a plurality of decoded signals corresponding to the plurality of data signals according to the plurality of log-likelihood ratios.

2. The method of claim 1, wherein the step of determining the plurality of hypothetical signal levels according to the plurality channel information comprises:
obtaining the channel coefficients according the channel information.

3. The method of claim 1, wherein the step of obtaining the pre-processed signal according to the received signal comprises:
obtaining the pre-processed signal by subtracting an estimated interference-plus-noise level from the received signal.

4. The method of claim 1, wherein the step of obtaining the pre-processed signal according to the received signal comprises:
obtaining the pre-processed signal by multiplying the received signal by a certain signature through a correlating unit.

5. The method of claim 1, wherein the certain signature is an interleaver, and the multiple access communication system is an interleave-division multiple access (IDMA) system.

6. The method of claim 1, wherein the certain signature is a spreading code, and the multiple access communication system is a code-division multiple access (CDMA) system.

7. The method of claim 1, wherein the user assigned with a unique signature is a degenerate case of multiple users assigned with the same signature.

8. The method of claim 1, wherein the step of calculating the plurality of log-likelihood ratios corresponding to the plurality of users according to the pre-processed signal and the plurality of hypothetical signal levels comprises:
calculating a plurality of symbol-level probabilities of the plurality of hypothetical signal levels given the pre-processed signal are obtained at the receiving device;
calculating a plurality of bit-level probabilities corresponding to the plurality of users according to the plurality of symbol-level probabilities; and
calculating the plurality of log-likelihood ratios corresponding to the plurality of users according to the plurality of bit-level probabilities.

9. The method of claim 8, wherein the step of calculating the plurality of symbol-level probabilities comprises:
calculating symbol-level probabilities of hypothetical signal levels given the pre-processed signals are obtained at the receiving device according to a priori probabilities;
wherein a priori probabilities are obtained from the receiving device in an earlier iteration.

10. A receiving device, comprising:
a multilevel detection unit, configured to perform following steps:
determining a plurality of hypothetical signal levels according to a plurality of channel information;
obtaining a pre-processed signal according to a received signal received by the receiving device, wherein the pre-processed signal comprises a mixture of a plurality of transmitted signals from the plurality of transmitting devices, and the plurality of transmitted signals are generated according to a plurality of signatures and encoded according to a plurality of data signals;
calculating a plurality of symbol-level probabilities according to the pre-processed signal and the hypothetical signal levels, wherein a number of signatures is less than a number of users; and
obtaining a plurality of log-likelihood ratios corresponding to the plurality of users;
a plurality of decoding units, configured to generate a plurality of decoded signals corresponding to the plurality of data signals according to the plurality of log-likelihood ratios.

11. The receiving device of claim 10, wherein the multilevel detection unit is configured to perform the step of determining the plurality of hypothetical signal levels according to the plurality channel information comprises:
obtaining the channel coefficients according the channel information.

12. The receiving device of claim 10, wherein the pre-processed signal is obtained by subtracting an estimated interference-plus-noise level from the received signal.

13. The receiving device of claim 10, further comprising a correlating unit, wherein the step of obtaining the pre-processed signal according to the received signal comprises:
obtaining the pre-processed signal by multiplying the received signal by a certain signature through a correlator unit.

14. The receiving device of claim 10, wherein the certain signature is an interleaver.

15. The receiving device of claim 10, wherein the certain signature is a spreading code.

16. The receiving device of claim 10, wherein the user assigned with a unique signature is a degenerate case of multiple users assigned with the same signature.

17. The receiving device of claim 10, wherein the multilevel detection unit is further configured to perform following steps, for calculating the plurality of log-likelihood ratios corresponding to the plurality of users according to the pre-processed signal and the plurality of hypothetical signal levels:
calculating a plurality of symbol-level probabilities of the plurality of hypothetical signal levels given the pre-processed signal are obtained at the receiving device;
calculating a plurality of bit-level probabilities corresponding to the plurality of users according to the plurality of symbol-level probabilities; and
calculating the plurality of log-likelihood ratios corresponding to the plurality of users according to the plurality of bit-level probabilities.

18. The receiving device of claim 10, wherein the step of calculating the plurality of symbol-level probabilities comprises:
calculating symbol-level probabilities of hypothetical signal levels given the pre-processed signals are obtained at the receiving device according to a priori probabilities;
wherein a priori probabilities are obtained from the receiving device in an earlier iteration.
